(19) United States
(12) Patent Application Publication
(10) Pub. No.: US 2025/0304401 A1
(43) Pub. Date: Oct. 2, 2025

(54) POST-PROCESSING APPARATUS AND IMAGE FORMING SYSTEM INCLUDING POST-PROCESSING APPARATUS

(71) Applicant: Konica Minolta, Inc., Tokyo (JP)

(72) Inventor: Eriko KOZAKI, Tokyo (JP)

(21) Appl. No.: 19/086,093

(22) Filed: Mar. 20, 2025

(30) Foreign Application Priority Data
Mar. 28, 2024 (JP) 2024-053770

(51) Int. Cl. B65H 35/06; B65H 37/00

(52) U.S. Cl. CPC B65H 35/06; B65H 37/00; B65H 2601/511

(57) ABSTRACT

Disclosed is a post-processing apparatus including: a conveyor that conveys a sheet, wherein a plurality of functional units that perform different types of processing on the sheet conveyed by the conveyor are selectively attachable and detachable to and from the post-processing apparatus; and a slitter that is one of the plurality of functional units, and has a variable cut waste width. The slitter includes: at least two cutters that are disposed in a same functional unit and are disposed at different positions in a conveyance direction of the sheet; and a relative position adjuster capable of adjusting relative positions of the at least two cutters in a direction orthogonal to the conveyance direction.

### CROSS-REFERENCE TO RELATED APPLICATIONS

The entire disclosure of Japanese Patent Application No. 2024-053770 filed on Mar. 28, 2024, is incorporated herein by reference in its entirety.

### BACKGROUND OF THE INVENTION

### Technical Field

The present invention relates to a post-processing apparatus and an image forming system.

### Description of Related Art

There is a post-processing apparatus that cuts a sheet formed by an image forming apparatus in a conveyance direction and divides the sheet into a plurality of pieces in a direction orthogonal to the conveyance direction of the sheet. As such a post-processing apparatus, a cutting apparatus disclosed in Japanese Unexamined Patent Publication No. 2012-91278 is conventionally known.

In this, three or more cutting device sections for cutting a sheet in a conveyance direction are provided side by side in the conveyance direction. Each of the cutting device sections includes a slitter in which an upper rotary blade and a lower rotary blade are rubbed together to cut the sheet in the conveyance direction, and a slitter moving mechanism that moves the slitter to an arbitrary position in a direction orthogonal to the conveyance direction.

Then, the slitter moving mechanism and the guide member moving mechanism are controlled on the basis of the generation pattern of cut wastes stored in the storage section, so that the slitter and the guide member can be arranged at predetermined set positions.

The cutting device section and the waste removal device section are each unitized. On the conveyance path, a plurality of cutting device sections are arranged from the sheet feed side, and a plurality of waste removal device sections are arranged on the downstream side thereof.

When such a post-processing apparatus is used, the position of the slitter of each cutting device section and the position of the guide member of each waste removal device section are appropriately adjusted, and thus it is possible to adjust the width of the cut wastes in accordance with the created commercial material.

### SUMMARY OF THE INVENTION

However, since the above-described sheet processing apparatus needs a plurality of cutting device sections (a plurality of cutting units) in order to have a function of adjusting the cut waste width, an installation space for the plurality of cutting units is required. For this reason, when the present invention is applied to an in-line type image forming system in which a plurality of functional units can be selectively attached and detached, the plurality of units are occupied in order to vary the width of the cut wastes, and thus selectable functions are limited.

The present invention has been made in view of such circumstances, and a main object thereof is to provide a post-processing apparatus that can include, as one of functional units, a single unit having a function that can vary a cut waste width, and an image forming system including the post-processing apparatus.

To achieve at least one of the abovementioned objects, according to an aspect of the present invention, a post-processing apparatus reflecting one aspect of the present invention is a post-processing apparatus comprising:
a conveyor that conveys a sheet, wherein a plurality of functional units that perform different types of processing on the sheet conveyed by the conveyor are selectively attachable and detachable to and from the post-processing apparatus; and
a slitter that is one of the plurality of functional units, and has a variable cut waste width, wherein
the slitter comprises:
   at least two cutters that are disposed in a same functional unit and are disposed at different positions in a conveyance direction of the sheet; and a relative position adjuster capable of adjusting relative positions of the at least two cutters in a direction orthogonal to the conveyance direction.

To achieve at least one of the abovementioned objects, according to another aspect of the present invention, a Image forming system reflecting one aspect of the present invention is an image forming system comprising:
an image forming apparatus that forms an image on a sheet; and
the post-processing apparatus that performs post-processing on the sheet on which the image has been formed by the image forming apparatus.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating a schematic configuration of an image forming system according to the present embodiment;

FIG. 2 is a functional block diagram illustrating a control structure of the image forming system according to the present embodiment;

FIG. 3 is a perspective view illustrating a schematic configuration of a slitter (variable bleed width slitter) according to the present embodiment. is an overall side view of the fixing device according to the embodiment of the present invention;

FIG. 4 is a diagram illustrating a schematic configuration of a cutter used in the slitter according to the present embodiment;

FIG. 5 is a diagram illustrating a drive mechanism for rotating a rotary shaft of the slitter according to the present embodiment;

FIG. 6A is a perspective view illustrating a pair of upper and lower rotary slide bodies (an upper blade unit and a lower blade unit) used in a cutter of a slitter according to the present embodiment;

FIG. 6B is a sectional view of the rotary slide body of FIG. 6A;

FIG. 7A is a cross-sectional view illustrating a mechanism for rotating an upper rotary slide body together with a rotary shaft according to the present embodiment;

FIG. 7B is a cross-sectional view illustrating a mechanism for rotating a lower rotary slide body together with a rotary shaft according to the present embodiment;

FIG. 8 is a perspective view of a drive mechanism that drives the respective cutters in the axial direction of the rotating shaft, as viewed from the downstream side in the conveyance direction of the sheet;

FIG. 9 is a plan view illustrating a drive mechanism that drives each cutter in an axial direction of a rotary shaft;

FIG. 10A is a view of a drive mechanism that drives each cutter on the upstream side in the conveyance direction of the sheet in the axial direction of the rotation shaft, as viewed from the downstream side;

FIG. 10B is a view of a drive mechanism for driving each cutter on the downstream side in the sheet conveyance direction in the axial direction of the rotation shaft, as viewed from the downstream side;

FIG. 11 is a table illustrating an aspect of cutting a sheet using the slitter according to the present embodiment;

FIG. 12A is a view of a portion where the cutter of the slitter according to the present invention is provided, as seen from the upstream side in the conveyance direction of the sheet;

FIG. 12B is a view of a portion where the cutter of the slitter according to the present invention is provided, as seen from the downstream side in the conveyance direction of the sheet;

FIG. 13A is a view of the upstream cutter of the slitter according to the present invention from the upstream side in the conveyance direction of the sheet;

FIG. 13B is a diagram of the upstream cutter of the slitter according to the present invention when viewed from the downstream side in the conveyance direction of the sheet;

FIG. 14A is a view of the downstream-side cutter of the slitter according to the present invention seen from the upstream side in the conveyance direction of the sheet;

FIG. 14B is a view of the downstream-side cutter of the slitter according to the present invention seen from the downstream side in the conveyance direction of the sheet;

FIG. 15 is a perspective view showing a housing attached to a cutter (rotary slide body) used in the slitter according to the present invention and various members attached to the housing;

FIG. 16 is a cross-sectional view of the slitter according to the present invention, cut along FIG. 12A and α-α-ray of FIG. 12B;

FIG. 17 is a perspective view illustrating a state of being cut along FIG. 12A and α-α-ray of FIG. 12B;

FIG. 18A is a view of the waste holding member and the height difference forming means provided in the cutter of the slitter according to the present embodiment when viewed from the downstream side in the conveyance direction;

FIG. 18B is a view illustrating the function of the waste pressing member provided in the cutter of the slitter according to the present embodiment; and

FIG. 18C is a diagram illustrating a function of a height difference forming means provided in the cutter of the slitter according to the present embodiment.

### DETAILED DESCRIPTION

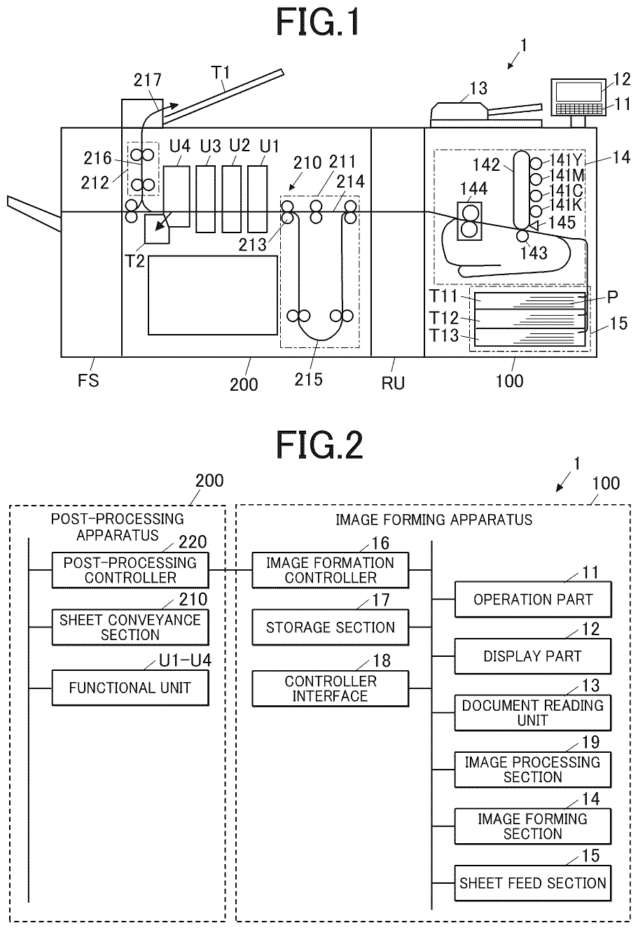

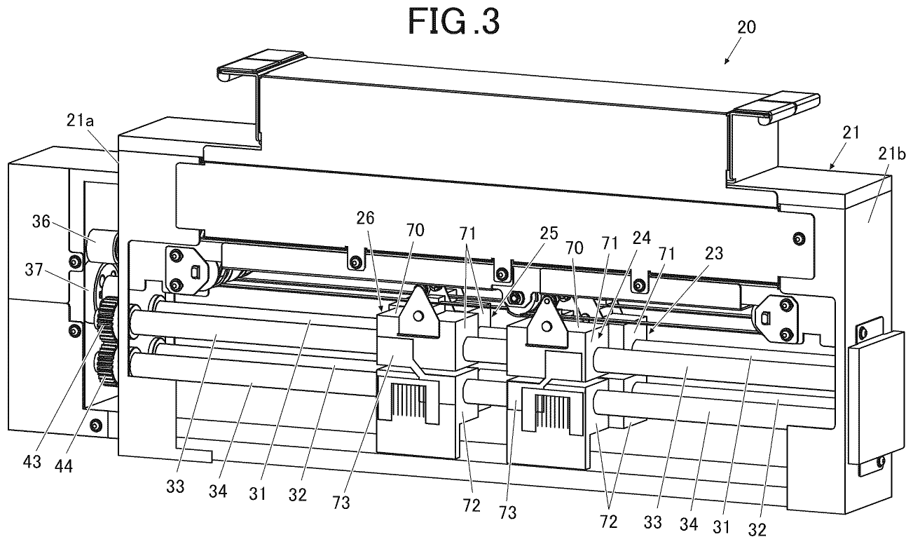

Hereinafter, embodiments of the present invention will be described with reference to the drawings. However, the scope of the invention is not limited to the disclosed embodiments or illustrated examples. As shown in FIGS. 1 and 2, the image forming system 1 according to the present embodiment includes an image forming apparatus 100, a relay unit RU, a post-processing apparatus 200, and a finisher FS.

The image forming apparatus 100 forms a color image by an electrophotographic method on the basis of image data obtained by reading an image from a document or image data received from an external device. The image forming apparatus 100 includes an operation part 11 and a display part 12, an document reading unit 13, an image forming section 14, a sheet feed section 15, an image formation controller 16, a storage section 17, a controller interface (IF) 18, and an image processing section 19.

The operation part 11 includes a touch screen formed to cover a display screen of the display part 12, and various operation buttons such as numeric buttons and a start button, and outputs an operation signal based on a user's operation to the image formation controller 16.

The display part 12 includes a liquid crystal display (LCD), and displays various screens in accordance with an instruction of a display signal input from the image formation controller 16.

The document reading unit 13 includes an automatic document feeder (ADF), a scanner, and the like, and outputs image data obtained by reading an image of a document to the image formation controller 16.

The image forming section 14 forms an image on a sheet supplied from the sheet feed section 15 on the basis of the image data subjected to image processing. The image forming section includes photoconductor drums 141Y, 141M, 141C, and 141K corresponding to respective colors of yellow (Y), magenta (M), cyan (C), and black (K), an intermediate transfer belt 142, a secondary transfer roller 143, a fixing section 144, a density sensor 145, and the like.

The 141Y of the photosensitive drum is uniformly charged, and is then scanned and exposed to a laser beam based on the yellow image, so that an electrostatic image is formed. Next, the yellow color is applied to the electrostatic latent image on the photosensitive drum, and development is performed. For the other photosensitive drums 141M, 141C, and 141K, the same processing as that for the photosensitive drum 141Y is performed, except that the colors to be handled are different.

The toner images in the respective colors formed on the photosensitive drums 141Y, 141M, 141C, and 141K are sequentially transferred onto the rotating intermediate transfer belt 142 (primary transfer). That is, a color toner image in which the toner images of four colors are superimposed is formed on the intermediate transfer belt 142. The color toner image on the intermediate transfer belt 142 is collectively transferred onto a sheet by the secondary transfer roller 143 (secondary transfer).

The fixing section 144 includes a heating roller that heats the sheet onto which the color toner image has been transferred and a pressure roller that presses the sheet, and fixes the color toner image onto the sheet by heating and pressing.

The sheet feed section 15 includes sheet feed trays T11 to T13 and supplies a sheet to the image forming section 14. Each of the sheet feed trays T11 to T13 stores sheets of a sheet type and a size determined in advance for each sheet feed tray.

The image formation controller 16 includes a CPU, a ROM, and a memory.

The CPU reads out various processing programs stored in the ROM and controls the operation of each unit of the image forming apparatus 100 according to the programs. Furthermore, when performing post-processing on the output sheet, the CPU instructs the post-processing apparatus 200 to perform predetermined post-processing.

The post-processing apparatus 200 is an apparatus that performs post-processing on the sheet output from the relay unit RU as necessary. Examples of the post-processing include slitter processing, bleed slitter processing, CD cutting processing, creasing processing, and FD/CD sewing machine processing. These kinds of post-processing are not essential, and the post-processing is executed only when instructed by the image forming apparatus 100. When the post-processing is not performed, the post-processing apparatus 200 conveys the conveyed sheet to the finisher FS as it is.

The post-processing apparatus 200 includes a sheet conveyance section 210 (conveyor), functional units (post-processing modules) U1 to U4, a purge tray T1 that ejects a sheet to be purged from the post-processing apparatus 200, and a card tray T2 that ejects a sheet cut into a predetermined size by the post-processing apparatus 200.

The sheet conveyance section 210 conveys the sheet conveyed from the relay unit RU to the functional units U1 to U4. Thereafter, the sheet subjected to the post-processing in the functional unit is conveyed to various trays (purge tray T1 and card tray T2) or the finisher FS.

The sheet conveyance section 210 includes a long sheet conveyance section 211 and a purge conveyance section 212. The sheet conveyance section 210 includes a plurality of conveyance roller pairs 213 and includes conveyance paths 214 to 217 as illustrated in FIG. 1. That is, the sheet conveyance section 210 includes a straight conveyance path 214 that corrects the skew of the sheet to be conveyed to the functional unit U1, and a bypass path 215 that bypasses the long sheet to be conveyed to the functional unit U1 to perform alignment in the CD-direction (sheet width direction). Furthermore, the sheet conveyance section 210 includes a reverse sheet ejection path 216 that reverses the sheet after the post-processing by the functional units U1 to U4 and ejects the sheet to the finisher FS, and a dual purpose path 217 that serves as both a sheet ejection path that ejects the sheet to the purge tray T1 and a reverse path that reverses the sheet.

The sheet conveyance section 210 conveys, by a plurality of conveyance roller pairs 213, the print sheet conveyed from the image forming apparatus 100 to the post-processing section (functional units U1 to U4). Further, the sheet conveyance section 210 conveys the printing sheet subjected to the post-processing to the finisher FS. In the finisher FS, the sheet after the image formation is subjected to stapling, folding, punching, and the like.

The functional units U1 to U4 perform post-processing on the conveyed sheet.

The functional units U1 to U4 are manually selected and installed by the service person. For example, the most upstream functional unit U1 may be a top/bottom slitter, and the most downstream functional unit U4 may be a compact disk cutter (compact disk cutting unit) for compact disk cutting. In this case, the functional units U2 and U3 may be selected from a bleed cutting slitter, a creaser (lower convex) or a creaser (upper convex), FD-perforation, CD-perforation, and the like.

The bleed cutting slitter has a function of cutting, along the conveyance direction, a margin between the products adjacent to each other in the direction orthogonal to the conveyance direction of the sheet. The creaser (downwardly convex) or the creaser (upwardly convex) has a function of performing crease processing on a sheet. The FD perforation or the CD perforation has a function of performing FD/CD sewing machine processing for forming a perforation in a sheet.

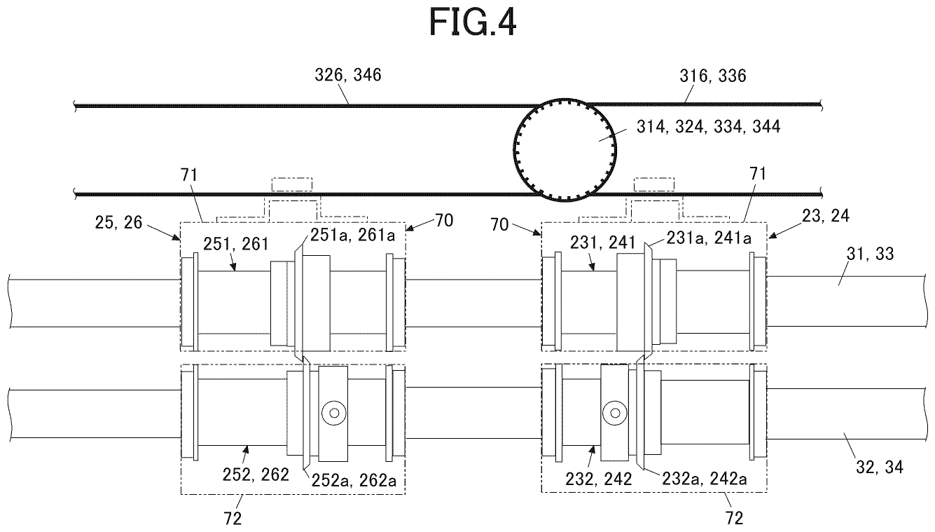

In the above-described functional units U1 to U4, modules selected in accordance with functions required by the user are detachably attached to the unit housing receivers, and required functions are completed on a module-by-module basis. Among them, the one shown in FIG. 3 is a variable bleed width slitter 20 capable of cutting by adjusting the bleed width among the bleed cutting slitters.

Hereinafter, the variable bleed width slitter 20 will be described in detail. Note that a conveyance direction of a sheet may be referred to as a front-rear direction of the sheet, an upstream side in the conveyance direction of the sheet may be referred to as a front side of the sheet, and a downstream side in the conveyance direction of the sheet may be referred to as a rear side. Further, a horizontal direction orthogonal to the conveyance direction of the sheet may be described as a right-left direction with respect to the sheet.

As illustrated in FIG. 3, the variable bleed width slitter 20 includes a plurality of cutters 23, 24, 25, and 26 for dove cutting when the sheet is divided into a plurality of pieces in the conveyance orthogonal direction.

That is, in the unit housing 21, a plurality of sets of a plurality of cutters disposed at different positions with respect to the conveyance direction of the sheet conveyed by the sheet conveyance section 210 are provided at different positions in the conveyance orthogonal direction of the sheet.

In this example, the cutters (23 and 24, and 25 and 26) are arranged in two different places with respect to the conveyance direction of the sheet. The paired cutters (23 and 24, and 25 and 26) arranged in two different places in the conveyance direction of the sheet are provided in two sets, and are arranged in different positions in a direction orthogonal to the conveyance direction. Therefore, in this embodiment, the cutters 23, 24, 25, and 26 are provided at four positions, i.e., front, rear, left, and right positions in the sheet conveyance direction in the unit housing 21.

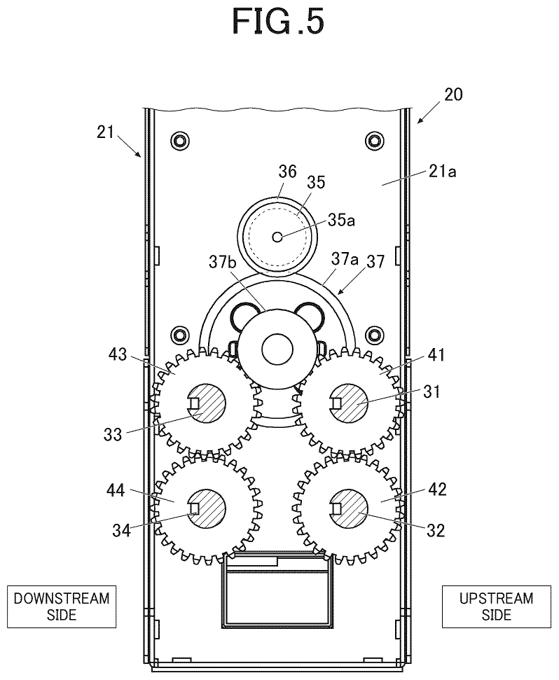

As also illustrated in FIG. 4, the respective cutters 23, 24, 25, and 26 are provided on a pair of upper and lower rotating shafts (31 and 32, and 33 and 34) extending in a direction orthogonal to the conveyance direction of the sheet. Two pairs of upper and lower rotating shafts (31 and 32, and 33 and 34) are provided at a predetermined interval in front and rear in the conveyance direction of the sheet. The respective rotation axes are provided so as to be parallel to each other.

On the upper rotating shafts 31 and 33, upper blade units 231, 241, 251, and 261 as rotary slide bodies including upper cutter blades 231a, 241a, 251a, and 261a are provided so as to be movable in the axial direction of the rotating shafts 31 and 33. In addition, on the lower rotary shafts 32.34, lower blade units 232, 242, 252, and 262 as rotary slide bodies including lower cutter blades 232a,242a, 252a, and 262a are provided so as to be movable in the axial direction of the rotary shafts 32 and 34.

An upper housing 71 is attached around the upper blade units 231, 241, 251, and 261. In addition, a lower housing 72 is attached around the lower blade units 232, 242, 252, and 262. The upper housing 71 and the lower housing 72 are connected to each other by a connecting member 73 (illustrated in FIG. 3). Thus, the upper blade units 231, 241, 251, and 261 and the lower blade units 232, 242, 252, and 262 integrally slide on the rotation shaft.

The upper housing 71 and the lower housing 72 constitute the blade rest 70 that rotatably houses the upper cutter blades 231a, 241a, 251a, and 261a (upper blade units 231, 241, 251, and 261) and the lower cutter blades 232a, 242a, 252a, and 262a (lower blade units 232, 242, 252, and 262) that are paired vertically.

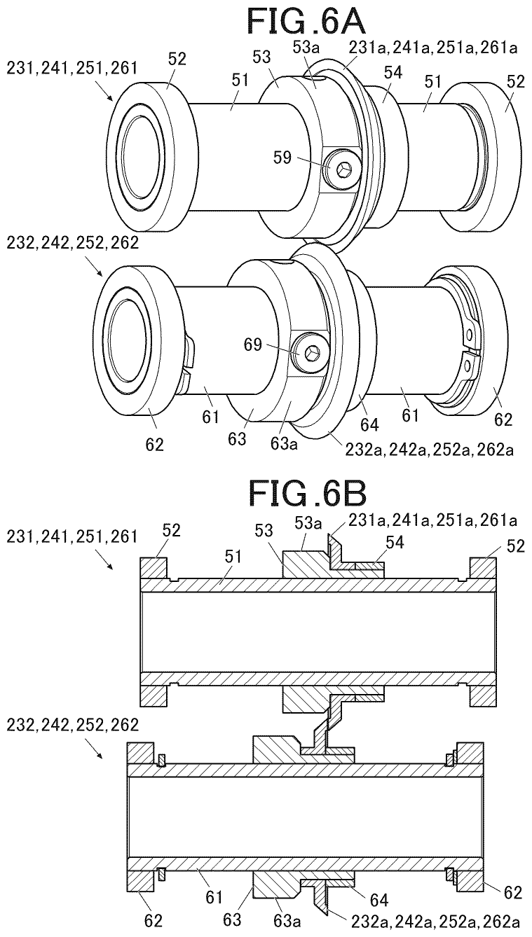

As illustrated in FIG. 5, the rotating shafts 31, 32, 33, and 34 are rotationally driven at the same time by a driving motor 35 that is a common power source.

The driving motor 35 is installed outside one of the side walls 21a and 21b that form a pair in the longitudinal direction of the unit housing 21, the side 21a. A motor shaft 35a of the driving motor 35 protrudes into the unit housing 21 via the sidewall 21a. Four rotating shafts 31 to 34 are disposed below the motor shaft 35a at predetermined intervals in the sheet conveyance direction (front-rear direction) and the up-down direction. Further, the respective rotating shafts 31 to 34 are arranged in parallel along a longitudinal direction of the unit housing 21. Furthermore, the rotating shafts 31 to 34 are rotatably supported by a pair of side walls 21a and 21b that face each other in the longitudinal direction of the unit housing 21. These rotating shafts 31 to 34 are rotationally driven at the same time by a series of gears.

In the driving motor 35, a driving wheel 36 attached to the motor shaft 35a is engaged with a large-diameter wheel 37a of a reduction wheel 37 in which the large-diameter wheel 37b and a small-diameter pinion 37a are concentrically integrated. Further, transmission gears 41 and 43 fitted to the respective upper rotating shafts 31 and 33 of the two sets of rotating shafts (31 and 32, and 33 and 34) forming upper and lower pairs are meshed with the pinion 37b. Furthermore, the respective upper transmission gears 41, 43 are meshed with transmission gears 42, 44 fitted and attached to the respective lower rotating shafts 32, 34 of the two sets of rotating shafts which are vertically paired.

Therefore, when the driving motor 35 rotates, the rotational power of the driving motor 35 is transmitted to the upper transmission gear 41.43 via the reduction gear 37. Furthermore, the rotational power is transmitted to the lower transmission gears 42 and 44 via the upper transmission gears 41 and 43. Thus, the four rotary shafts 31 to 34 rotate simultaneously. As a result, the pair of upper and lower cutter blades 231a, 232a, and 251a,252a on the upstream side cuts one side of the bleed of the sheet conveyed therebetween. The pair of upper and lower cutter blades 241a, 242a, and 261a,262a on the downstream side cuts the other side of the bleed of the sheet conveyed therebetween.

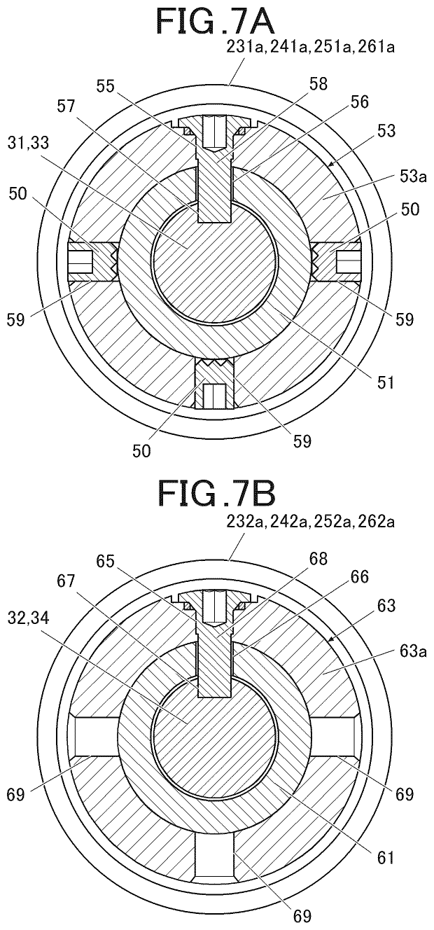

As illustrated in FIGS. 6A and 6B, the upper blade units 231, 241, 251, and 261 are composed of the following constituent members.
A cylindrical main body section 51 externally fitted to the upper rotary shafts 31, 33 slidably in the axial direction;
Bearing sections 52 externally fitted to both ends of the main body section 51;
A cutter blade holding cylinder 53 externally mounted in the middle of the main body section 51;
Cutter blades 231a, 241a, 251a, 261a pressed against the outer peripheral surface of the cutter blade holding tube 53
A holding ring 54 pressed against an outer peripheral surface of the cutter blade holding cylinder 53 for holding an attachment state of the cutter blade;

The cutter blade holding tube 53 includes a flange section 53a at one end. The cutter blade 231a, 241a, 251a, and 261a are externally fitted to the cutter blade holding tube 53 so as to be in contact with the 53a of the flange section. The cutter blade is fixed so as to be sandwiched between the flange section 53a of the cutter blade holding tube 53 and the holding ring 54.

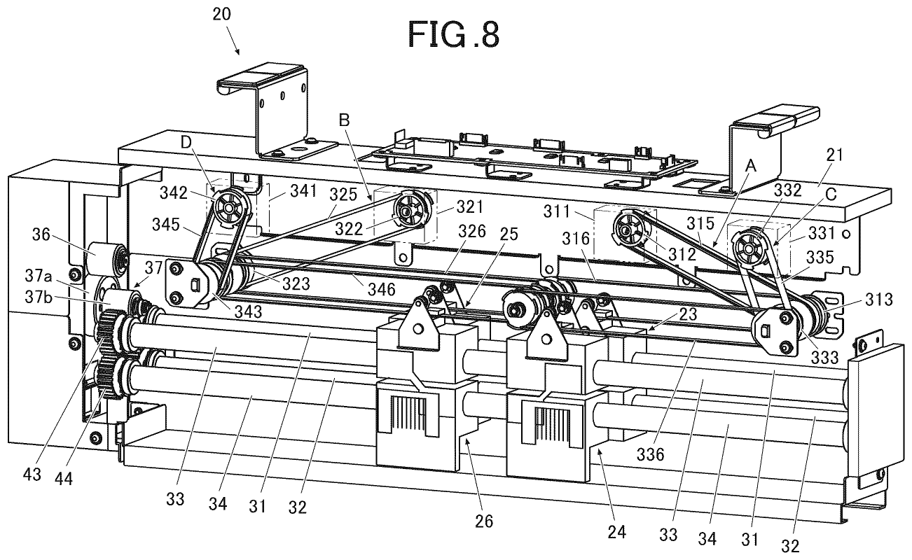

As illustrated in FIG. 7A, screw holes 55 are formed in the flange section 53a so as to penetrate therethrough in a radial direction. In addition, a through hole 56 is formed at a position of the main body section 51 which aligns with the screw hole 55. Furthermore, in the circumferential surfaces of the rotating shafts 31 and 33 aligned with the through holes 56, grooves 57 extending in the axial direction are formed. A power transmission screw 58 is screwed into the screw hole 55 so as to be inserted into the groove 57 via the through hole 56. A plurality of positioning holes 59 are formed through the flange section 53a of the cutter blade holding cylinder 53 so as to be out of phase with the screw holes 55. A set screw 50 is screwed into the positioning hole 59. The cutter blade holding tube 53 and the main body section 51 are firmly fixed by the set screws 50.

Therefore, when the rotating shafts 31 and 33 rotate, the power thereof is transmitted to the flange section 53a of the cutter blade holding cylinder 53 via the power transmission screw 58 to rotate the cutter blades 231a, 241a, 251a, and 261a press-fitted and fixed to the cutter blade holding cylinder 53. Further, since the flange section 53a is fixed to the main body section 51 via the set screw 50, the power transmitted to the flange section 53a is also transmitted to the main body section 51 as it is. Thus, the upper cutter blades 231a, 241a, 251a, and 261a rotate together with the main body section 51.

The upper housing 71 to be attached to the upper blade unit 231,241,251, 261 is locked to an outer peripheral surface of the bearing section 52 (attached so as not to inhibit rotation of the upper blade unit 231,241,251, 261).

Furthermore, as illustrated in FIGS. 6A and 6B, the lower blade units 232, 242, 252, and 262 include the following constituent members.
A cylindrical main body section 61 externally mounted on the lower rotating shafts 32 and 34 so as to be slidable in the axial direction;
Bearing sections 62 externally fitted to both ends of the main body section 61;
A cutter blade holding tube 63 externally mounted in the middle of the main body section 61;
The cutter blades 232a,242a, 252aa, 262a are press-fitted to the outer peripheral surface of the cutter blade holding cylinder 63
A holding ring 64 pressed against an outer peripheral surface of the cutter blade holding cylinder 63 for holding an installation state of the cutter blade The cutter blade holding tube 63 includes a flange section 63a at one end. Further, the cutter blades 232a,242a, 252aa, 262a are externally mounted on the cutter blade holding cylinder 63 so as to abut on the flange section 63a. The cutter blade 232a,242a, 252aa, and 262a are fixed so as to be sandwiched between the 63a of the flange section of the cutter blade holding tube 63 and the holding ring 64.

As illustrated in FIG. 7B, screw holes 65 are formed in the flange section 63a so as to penetrate therethrough in a radial direction. In addition, in a position of the main body section 61 aligned with the screw hole 65, a through hole 66 having a large diameter is formed in the axial direction of the rotating shaft. Furthermore, grooves 67 extending in the axial direction are formed at positions of the rotating shafts 32 and 34 aligned with the through holes 66. A power transmission screw 68 is screwed into the screw hole 65 so as to be inserted into the groove 67 via the through hole 66. A plurality of positioning holes 69 are formed in the flange section 63a of the cutter blade holding cylinder 63 so as to be out of phase with the screw holes 65. However, in this example, the positioning holes 69 are not particularly used (set screws are not attached).

Therefore, when the rotary shafts 32, 34 are rotated, the power thereof is transmitted to the flange section 63a of the cutter blade holding cylinder 63 through the power transmission screw 68 to rotate the cutter blades 232a,242a, 252aa, 262a press-fitted and fixed to the cutter blade holding cylinder 63. Further, since the flange section 63a is not fixed to the main body section 61, when the power transmission screw 68 starts rotating with the rotation of the rotating shafts 32 and 34, the inner peripheral surface of the through hole 66 of the main body section 61 abuts on the belly part of the power transmission screw 68, and the main body section 61 also rotates together. Accordingly, power is transmitted to the cutter blade holding cylinder 63 and the main body section 61 via the power transmission screw 68, and the cutter blades 232a,242a, 252aa, and 262a are rotated together with the main body section 61.

The lower housing 72 attached to the lower blade units 232, 242, 252, and 262 is locked to the outer peripheral surface of the bearing section 62 (attached so as not to interfere with the rotation of the lower blade units 232, 242, 252, and 262).

Further, the cutter blade holding cylinder 63 is not fixed to the main body section 61 and is slidable in the axial direction of the rotary shafts 32 and 34. A spring (not shown) is elastically mounted between the cutter blade holding cylinder 63 and a bearing section 62 disposed on the side opposite to the upper cutter blades 232a, 242a, 252a, 262a with respect to the lower cutter blades 231a, 241a, 251a, 261a. Thus, the lower cutter blade 232a, 242a, 252a, and 262a are urged so as to be pressed against the upper cutter blade 231a, 241a, 251a, and 261a in the axial direction. Therefore, even when there is a tolerance in the fixing positions of the upper cutter blades 231a, 241a, 251a, and 261a, the cutting edges of the upper cutter blades 231a, 241a, 251a, and 261a and the cutting edges of the lower cutter blades 232a, 242a, 252a, and 262a are brought into contact with each other in the axial direction. Thus, cutting of the sheet is not hindered.

### (Drive Mechanism of Upper Blade Unit and Lower Blade Unit)

The positions of the upper blade units 231,241,251 and 261 and the lower blade units 232, 242, 252, and 262, which are paired up and down as described above, in the axial direction of the rotation shaft are interlocked by the coupling member 73 attached to the upper housing 71 and the lower housing 72. Therefore, the upper cutter blade 231a, 241a, 251a, 261a and the lower cutter blade 232a, 242a, 252a, 262a can slide in the axial direction on the rotary shaft while maintaining a state in which they are not separated in the axial direction.

The upper blade units 231,241,251 and 261 and the lower blade units 232, 242, 252, and 262, which are paired vertically, are slidable in the axial direction of the rotating shafts 31 to 34 by a driving belt (an endless belt described later) fixed to the upper housing 71 locked to the upper blade units.

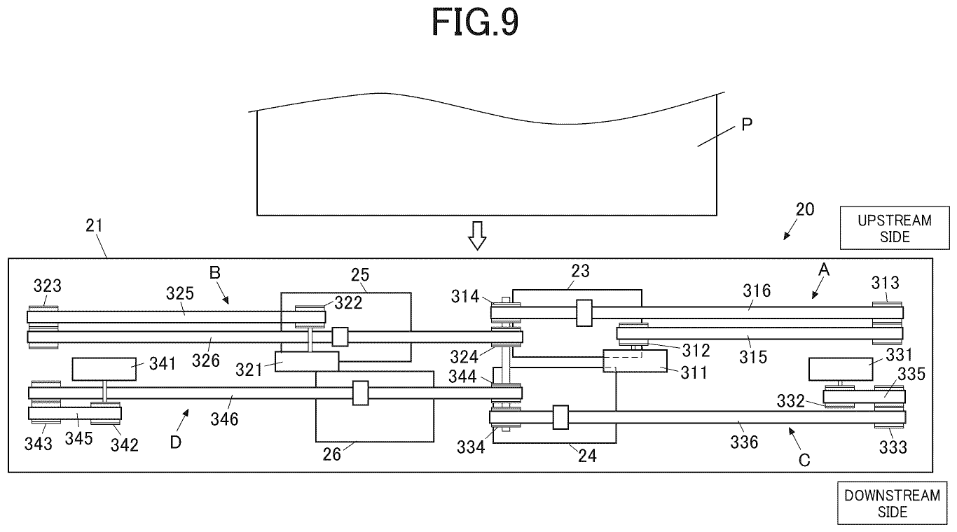

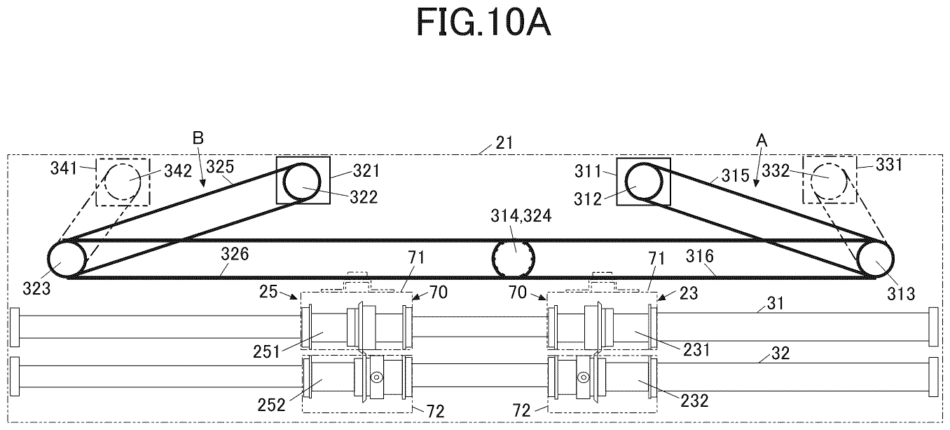

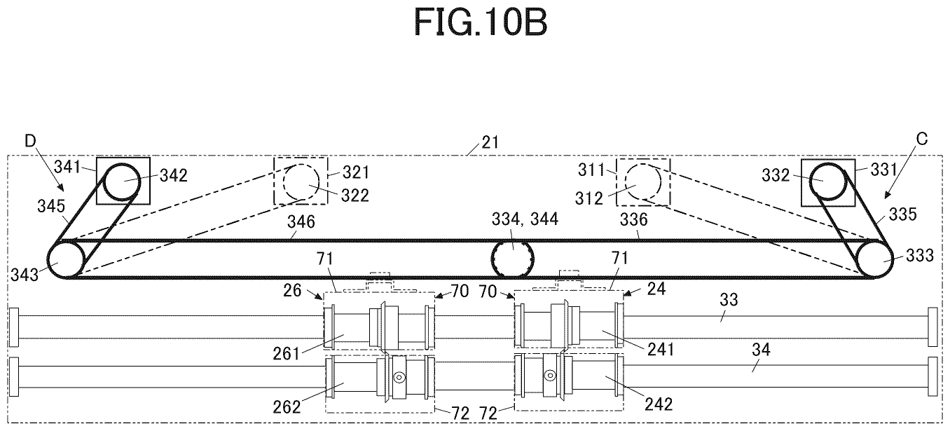

As illustrated in FIGS. 8 and 9, the respective left and right cutters 23 and 25 on the upstream side in the conveyance direction and the respective left and right cutters 24 and 26 on the downstream side in the conveyance direction are driven by belts using separate drive motors 311, 321, and 331.341 as power sources.

Of the cutters 23 and 25 on the upstream side in the conveyance direction, the drive mechanism A that moves the cutter 23 on the right side when viewed from the downstream side has the following configuration, as illustrated in 10A of the drawing.
(1) A first drive motor 311 provided on the right side of the upper center in the unit housing 21 when viewed from the downstream side;
(2) A first driving pulley 312 fixed to a motor shaft of the first drive motor 311;
(3) A first intermediate pulley 313 that is disposed near an end portion on one side (the right side when viewed from the downstream side) in a longitudinal direction of the unit housing 21, above the upper rotary shaft 31, and below the first drive pulley 312 and that is rotatably disposed around a shaft parallel to a motor shaft of the first drive motor 311;
(4) A first terminal pulley 314 that is disposed substantially in the center of the unit housing 21 in a longitudinal direction and above the upper rotary shaft 31 and is disposed rotatably around a shaft parallel to a motor shaft of the first drive motor 311;
(5) A first endless belt 315 stretched between the first drive pulley 312 and the first intermediate pulley 313;
(6) A second endless belt 316 bridged between the first intermediate pulley 313 and the first terminal pulley 314;

An upper portion of the upper housing 71 locked to the upper blade unit 231 forming the cutter 23 is fixed to the second endless belt 316. Therefore, the axial position of the cutter 23 on the right side when viewed from the downstream side of the upstream side in the conveyance direction on the rotating shafts 31 and 32 is adjusted by controlling the first drive motor 301.

Of the cutters on the upstream side in the conveyance direction, the drive mechanism B that moves the cutter 25 on the left when viewed from the downstream side has the following configuration, as also illustrated in the 10A of the figure.
(1) A second drive motor 321 provided to the left of the upper center in the unit housing 21 when viewed from the downstream side;
(2) A second driving pulley 322 fixed to a motor shaft of the second drive motor 321;
(3) A second intermediate pulley 323 that is disposed near an end portion on the other side (the left side when viewed from the downstream side) in the longitudinal direction of the unit housing 21, above the upper rotary shaft 31, and below the second drive pulley 322 and is rotatably disposed around a shaft parallel to the motor shaft of the second drive motor 321
(4) A second terminal pulley 324 that is disposed substantially in the center of the unit housing 21 in the longitudinal direction and above the upper rotating shaft 31 and is disposed rotatably around a shaft parallel to a motor shaft of the second drive motor 321;
(5) A third endless belt 325 looped over the second drive pulley 322 and the second intermediate pulley 323;
(6) A fourth endless belt 326 bridged between the second intermediate pulley 323 and the second terminal pulley 324;

An upper portion of the upper housing 71 locked to the upper blade unit 251 forming the cutter 25 is fixed to the fourth endless belt 326. Accordingly, the axial position of the cutter 25 on the left side when viewed from the downstream side of the upstream side in the conveyance direction on the rotating shafts 31 and 32 is adjusted by controlling the second drive motor 321.

Of the cutters on the downstream side in the conveyance direction, the drive mechanism C that moves the cutter 24 on the right as viewed from the downstream side has the following configuration, as also illustrated in the 10B of the figure.
(1) A third drive motor 331 provided at an upper portion in the vicinity of a right end portion when viewed from the downstream side in the longitudinal direction in the unit housing 21;
(2) A third driving pulley 332 fixed to a motor shaft of the third drive motor 331;
(3) A third intermediate pulley 333 that is disposed near a right end portion as viewed from the downstream side in the longitudinal direction of the unit housing 21, above the upper rotary shaft 33, and below the third drive pulley 332 and is rotatably disposed around a shaft parallel to a motor shaft of the third drive motor 331
(4) A third terminal pulley 334 that is disposed substantially in the center of the unit housing 21 in the longitudinal direction and above the upper rotary shaft 33 and is disposed rotatably around a shaft parallel to a motor shaft of the third drive motor 331;
(5) A fifth endless belt 335 looped over the third drive pulley 332 and the third intermediate pulley 333;
(6) A sixth endless belt 336 stretched between the third intermediate pulley 333 and the third terminal pulley 334

An upper portion of the upper housing 71 locked to the upper blade unit 241 constituting the right cutter 24 as viewed from the downstream side of the downstream side in the conveyance direction is fixed to the sixth endless belt 336. Therefore, the axial position of the cutter 24 on the right side as viewed from the downstream side in the conveyance direction on the rotary shafts 33 and 34 is adjusted by controlling the third drive motor 331.

Of the cutters on the downstream side in the conveyance direction, the drive mechanism D that moves the cutter 26 on the left as viewed from the downstream side has the following configuration, as also illustrated in the 10B of the figure.
(1) A fourth drive motor 341 provided at an upper portion in the vicinity of a left end portion when viewed from the downstream side in the longitudinal direction in the unit housing 21;
(2) fourth drive pulleys 342 fixed to a motor shaft of the fourth drive motor 341
(3) The fourth intermediate pulley 343 is disposed near the left end portion as viewed from the downstream side in the longitudinal direction of the unit housing 21, above the upper rotary shaft 33, and below the fourth drive pulley 342, and is disposed rotatably around a shaft parallel to the motor shaft of the fourth drive motor 341.
(4) A fourth terminal pulley 344 that is disposed substantially in the center of the unit housing 21 in the longitudinal direction and above the upper rotating shaft 33 and that is disposed rotatably around a shaft parallel to a motor shaft of the fourth drive motor 341;
(5) A seventh endless belt 345 looped over the fourth drive pulley 342 and the fourth intermediate pulley 343;
(6) An eighth endless belt 346 bridged between the fourth intermediate pulley 343 and the fourth terminal pulley 344

An upper portion of the upper housing 71 locked to the upper blade unit 261 constituting the cutter 26 on the left side when viewed from the downstream side of the downstream side in the conveyance direction is fixed to the eighth endless belt 346. Therefore, the axial position of the cutter 26 on the left side as viewed from the downstream side in the conveyance direction on the rotary shafts 33 and 34 is adjusted by controlling the fourth drive motor 341.

Note that in this example, the first intermediate pulley 313 is a double pulley around which the first endless belt 315 and the second endless belt 316 are looped. The second intermediate pulley 323 is a double pulley around which the third endless belt 325 and the fourth endless belt 326 are looped. The third intermediate pulley 333 is a double pulley around which the fifth endless belt 335 and the sixth endless belt 336 are wound. The fourth intermediate pulley 343 is a double pulley around which the seventh endless belt 345 and the eighth endless belt 346 are wound.

The first terminal pulley 314, the second terminal pulley 324, the third terminal pulley 334, and the fourth terminal pulley 344 are provided on the same shaft so as to be independently rotatable.

In the above configuration example, two sets of cutter pairs (a cutter on the upstream side and a cutter on the downstream side) arranged in two different places in the conveyance direction of the sheet are provided in the direction orthogonal to the conveyance direction, and the cutters of the respective sets are independently movable in the direction orthogonal to the conveyance direction.

Therefore, by controlling at least one of the first drive motor 311 and the third drive motor 331, the width of one bleed can be adjusted by the pair of cutters 23 and 24 on the left side (the right side when viewed from the downstream side) in the conveyance direction. In addition, by controlling at least one of the second drive motor 321 and the fourth driving motor 341, the width of the other bleed can be adjusted by the pair of cutters 25 and 26 on the right side in the conveyance direction (the left side when viewed from the downstream side). Furthermore, in a case where only the cutters 23 and 25 on the upstream side or the cutters 24 and 26 on the downstream side are used, it is also possible to cut the sheet without bleed.

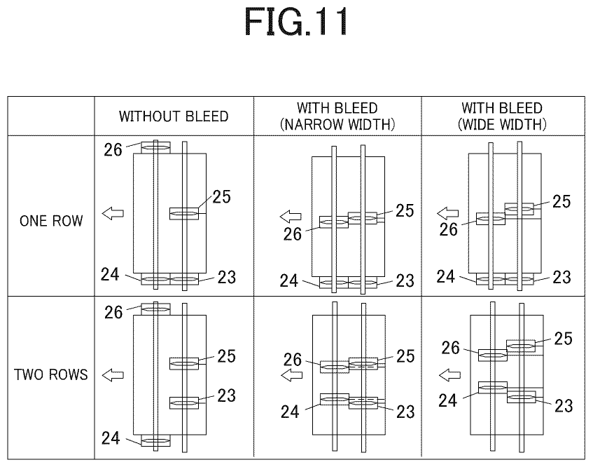

According to the above-described variable bleed width slitter 20, various cutting patterns can be achieved by combining the two cutters 23 and 25 on the upstream side and the two cutters 24 and 26 on the downstream side in the conveyance direction of the sheet. For example, as illustrated in FIG. 11, if it is desired to form two divided products adjacent to each other in a direction orthogonal to the conveyance direction, any one of the cutters (in this example, one cutter 25 on the upstream side) may be disposed at the dividing position. Furthermore, if it is desired to form three separate products adjacent to each other in the direction orthogonal to the conveyance direction, any two of the cutters (in this example, the two cutters 23 and 25 on the upstream side) may be arranged at the respective separation positions.

In addition, in a case where it is necessary to form a bleed at the dividing portion, as shown in the drawing, it is possible to adjust the bleed width (narrow width, wide width) by adjusting the relative position in the direction orthogonal to the conveyance direction of the cutter on the upstream side and the cutter on the downstream side which form a pair. At this time, by using a set of cutter pairs (e.g., the cutters 25 and 26) that precede and follow in the conveyance direction, one row of bleed can be formed at an arbitrary position in the sheet with an arbitrary bleed width.

In addition, when two sets of cutter pairs (23 and 24, and 25 and 26) which are located back and forth in the conveyance direction are used, two rows of bleeds can be formed at arbitrary positions in the sheet with an arbitrary bleed width.

Therefore, according to the above-described configuration, since it becomes possible to adjust the bleed width and cut the sheet with a single unit (the variable bleed width slitter 20), it becomes possible to form commercial products of various sizes from one sheet size without using multiple units.

Incidentally, as described above, in a case where two cutters (23 and 24, and 25 and 26) are disposed at different positions with respect to the conveying method in one unit (in the unit housing), it is necessary to appropriately convey the sheet to each cutter by a short distance. In addition, it is necessary to appropriately process the cut wastes and the cut sheets (main body). Therefore, the following accessory members are provided.

### (Sheet Guide Member)

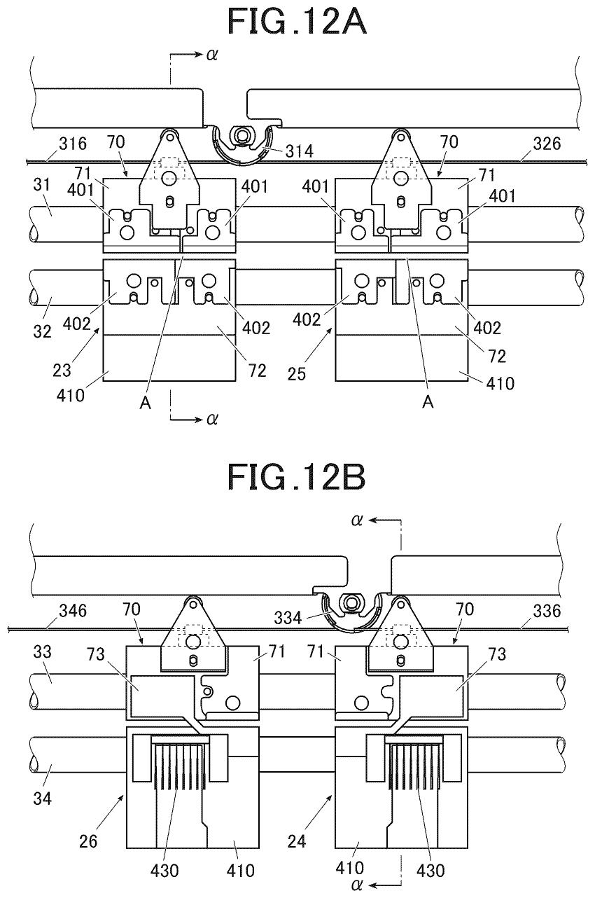

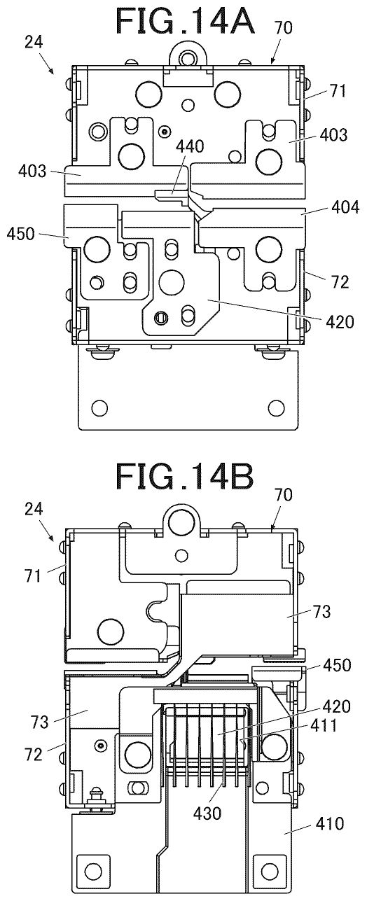

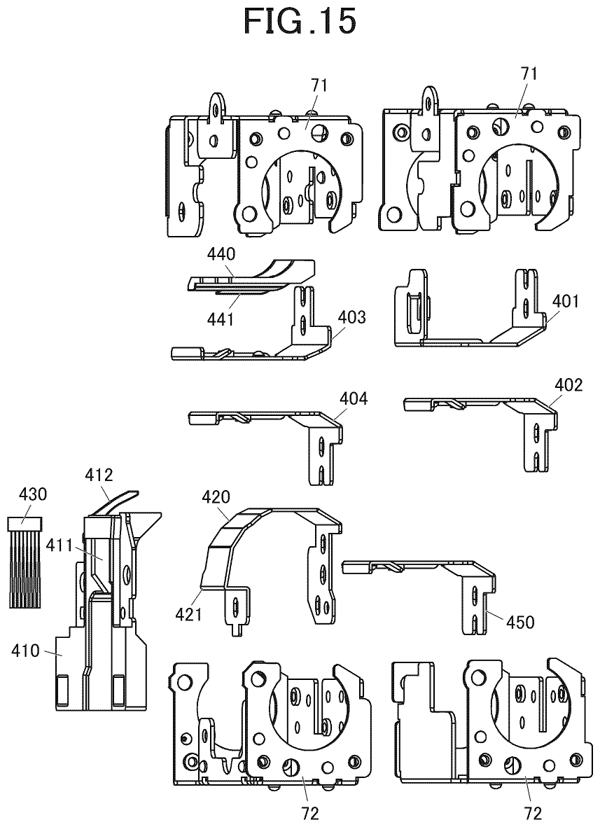

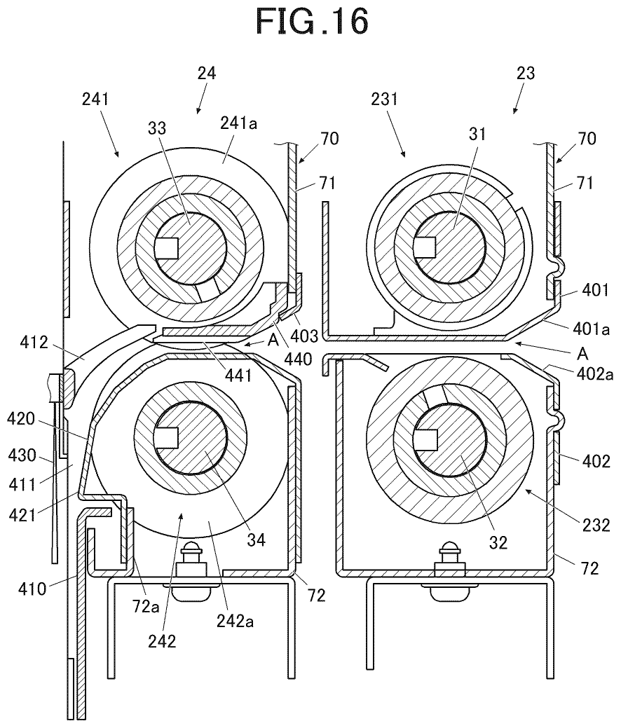

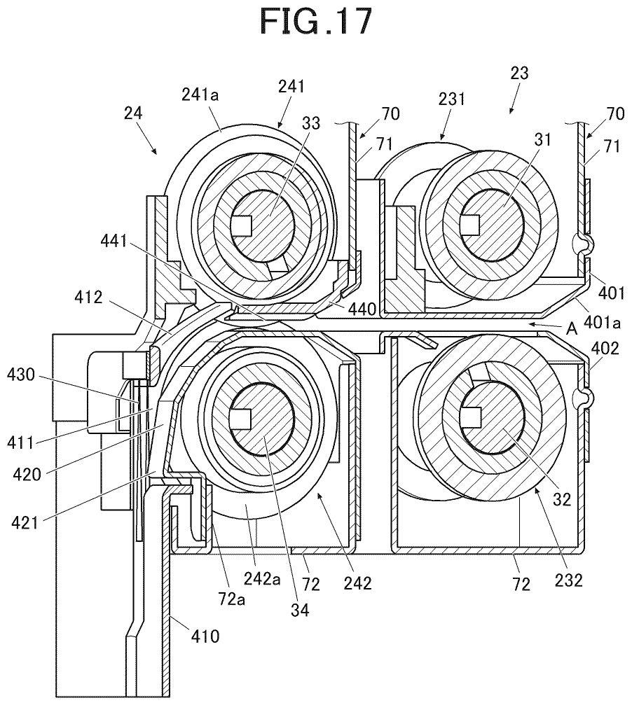

As illustrated in FIGS. 12 to 17, the cutters 23, 24, 25, and 26 of the variable bleed width slitter 20 are provided with sheet guide members 401, 402, 403, and 404 (sheet guide), respectively, between the upper housing 71 and the lower housing 72 of the blade rest 70.

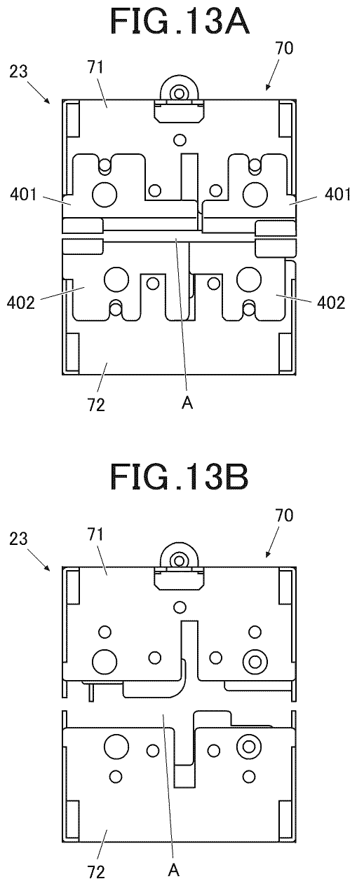

Note that FIGS. 13 to 18 illustrate the upstream cutter 24 and the downstream cutter 24 on the left side (the right side when viewed from the downstream side of the variable bleed width slitter 20) in the conveyance direction of the sheet, but the cutter on the right side in the conveyance direction also has substantially the same configuration except that the shape is inverted right and left with respect to the conveyance direction of the sheet.

The sheet guide members 401, 402, 403, and 404 are attached to a lower portion of the upper housing 71 and an upper portion of the lower housing 72, respectively, by appropriate fixing means such as screws. The upstream end portions of the sheet guide members 401, 402, 403, and 404 are provided with tapered sections 401a, 402a, 403a, and 404a which increase the size of a sheet receiving port in the vertical direction toward the upstream side. That is, each of the sheet guide members 401 and 403 attached to the lower portion of the upper housing 71 has a tapered section 401a,403a formed at the upstream end thereof so as to be inclined upward toward the upstream side. Further, the sheet guide members 402 and 404 attached to the upper portion of the lower housing 72 are formed with tapered sections 402a and 404a inclined downward toward the upstream side at the upstream-side end portions.

Each of the sheet guide members 401, 402, 403, and 404 is formed at least from the upstream end surface of the upper housing 71 and the lower housing 72 to a portion facing the conveyance path A between the upper blade units 231 and 241 and the lower blade units 232 and 242. That is, the sheet guide members 401 and 403 provided in the upper housing 71 are attached so as to cover at least from the end face on the upstream side of the upper housing 71 to the lower end opening portion of the upper housing 71 and not to interfere with the upper cutter blade 231a,241a portion. In addition, the sheet guide members 402 and 404 provided in the lower housing are attached so as to cover the upper end opening portion of the lower housing 72 from the end face on the upstream side of the lower housing 72 and not to interfere with the lower cutter blades 232a and 242a.

The shapes of the sheet guide members 401, 402, 403, and 404 are appropriately adjusted to avoid interference with other members on the upstream side and the downstream side, on the upper housing and the lower housing, and on the right side and the left side in the conveyance direction. It is preferable that a plurality of these sheet guide members 401, 402, 403, and 404 are provided in lower parts of the respective upper housings 71 and upper parts of the respective lower housings 72 along the axial directions of the rotating shafts 31, 32, 33, and 34.

Therefore, with the attachment of these sheet guide members 401, 402, 403, and 404, the sheet conveyed from the upstream side is reliably guided to the conveyance path A between the upper blade units 231, 241, 251, and 261 and the lower blade units 232, 242, 252, and 262 by the tapered sections 401a, 402a, 403a, and 404a of the upper and lower sheet guide members. Further, by adjusting the interval between the guide members facing each other in the vertical direction, the sheet can be held when the sheet is cut by the cutter, and the sheet can be smoothly cut.

### (Waste Ejection Member)

By adjusting the relative positions of the cutter 23.25 on the upstream side in the conveyance direction and the cutter 24.26 on the downstream side in the conveyance orthogonal direction, cutting waste having a desired width is formed. The cutting waste moves to the downstream side with the conveyance of the sheet, but needs to be appropriately ejected separately from the main body. Therefore, a waste ejection member 410 (waste ejector) including a waste ejection port 411 for ejecting the cutting wastes is provided on the downstream side of the place where the cutting wastes are generated.

The waste ejection member 410 is fixed to a downstream-side end surface of the lower housing 72 locked to the lower blade units 242 and 262 constituting the downstream-side cutters 24 and 26. The waste ejection port 411 is formed at a position lower than cutting positions of the pair of upper and lower cutter blades and opposite to the lower blade units 242 and 262.

In addition, a waste ejection claw 412 that guides cutting waste to the waste ejection port 411 is provided above the waste ejection port 411 of the waste ejection member 410. The waste ejection claw 412 is provided at a position close to the cutter blades 241a and 242a and extends obliquely upward from the upper edge portion of the waste ejection port 411 of the waste ejection member 410 toward the upstream side in the conveyance direction. Further, the waste ejection claw 412 is extended to the vicinity of the cutting positions of the pair of upper and lower cutter blades 241a and 242a, and the distal end thereof is disposed on the downstream side of the cutting positions of the cutter blades and on the upper side of the cutting positions of the cutter blades 241a and 242a.

Therefore, although the wastes cut by the pair of upper and lower cutter blades 241a and 242a move to the downstream side with the conveyance of the sheet, the wastes abut against the lower surfaces of the waste ejection claws 412 of the waste ejection member 410, are pushed by the waste ejection claws 412 to be guided downward, and are guided to the waste ejection port 411. Next, the cutting waste is ejected from the waste ejection port 411 to the downstream side of the waste ejection member 410, and drops into a waste reservoir (not illustrated).

### (Waste Conveying Member)

Although the wastes cut by the cutter 23.25 on the upstream side in the conveyance direction and the cutters 24, 26 on the downstream side are directed to the waste ejection port 411 by the waste ejection claw 412, a part of the wastes may not be completely ejected from the waste ejection port 411 and may fall into the lower housing 72. In order to prevent such a situation and reliably eject the cutting waste from the waste ejection port 411 of the waste ejection member 410, a waste conveying member 420 (waste conveyor) is attached to the lower housing 72 of the cutters 24 and 26 on the downstream side.

The waste conveying member 420 is formed so as to cover the periphery of the cutter blade holding tube 63 externally mounted in the middle of the main body section 61 of the lower blade unit 242, 262 except for the lower side. In the waste conveying member 420, a protruding section 421 that protrudes rearward (toward the downstream side) is formed in a portion that faces the waste ejection port 411 provided in the waste ejection member 410. The protruding section 421 protrudes so as to cover a lower end peripheral edge of the waste ejection port 411 from inside.

Furthermore, in this example, a standing wall 72a that protrudes upward from the bottom wall is provided inside the lower housing 72. The lower end of the waste conveying member 420 is brought into contact with and fixed to the standing wall 72a to reliably prevent the waste from entering the inside of the lower housing 72 (the inside of the waste conveying member 420).

Therefore, by providing such a waste conveying member 420, the cutting waste guided to the downstream side along the surface of the waste conveying member 420 is reliably ejected from the waste ejection port 411 to the outside of the cutters 24 and 26 in cooperation with the guide function of the waste ejection claw 412.

### (Discharging Member)

Incidentally, since the cutting waste guided to the waste ejection port 411 is charged, the cutting waste is likely to adhere to the peripheral edge of the waste ejection port 411 and accumulate. Therefore, in order to prevent this, a brush-like discharging member 430 (discharger) is provided at the waste ejection port 411. The discharging member 430 is fixed to a back surface of the waste ejection member 410 which is higher than the waste ejection port 411, and is formed by suspending a discharging brush from this part.

Therefore, the cutting waste guided to the waste ejection port 411 is discharged by the discharging member 430 and can be ejected smoothly without adhering to the peripheral edge of the waste ejection port 411.

### (Waste Pressing Member)

After the sheet is divided into the main body and the cutting waste by the cutter, the cutting waste is guided by the waste ejection claw 412 to be led downward and ejected to the outside from the waste ejection port 411.

However, since the variable bleed width slitter 20 of the present embodiment is configured to be able to vary the bleed width, the waste ejection claw 412 is required to cope with a case where the bleed width is narrow, and therefore, an arrangement region is limited. That is, as illustrated in the 18B of the drawing, a cutting waste P2 is formed adjacent to the main body P1 formed by the cutter on the upstream side, and therefore, it is necessary to avoid interfering with the conveyance of the main body even when the cutting waste is narrow. Therefore, the waste ejection claws 412 are made narrow and provided at positions as close to the cutter blade as possible. For this reason, in a case where the widths of the cut waste are set to be wide, when the cutting waste P2 is guided downward by the waste ejection claw 412, the waste ejection claw 412 locally presses one side of the cutting waste P2. Therefore, the cutting waste P2 is likely to be inclined (likely to be floated), comes into contact with the main body P1, and loses its posture, which leads to a disadvantage of inducing a JAM due to waste clogging.

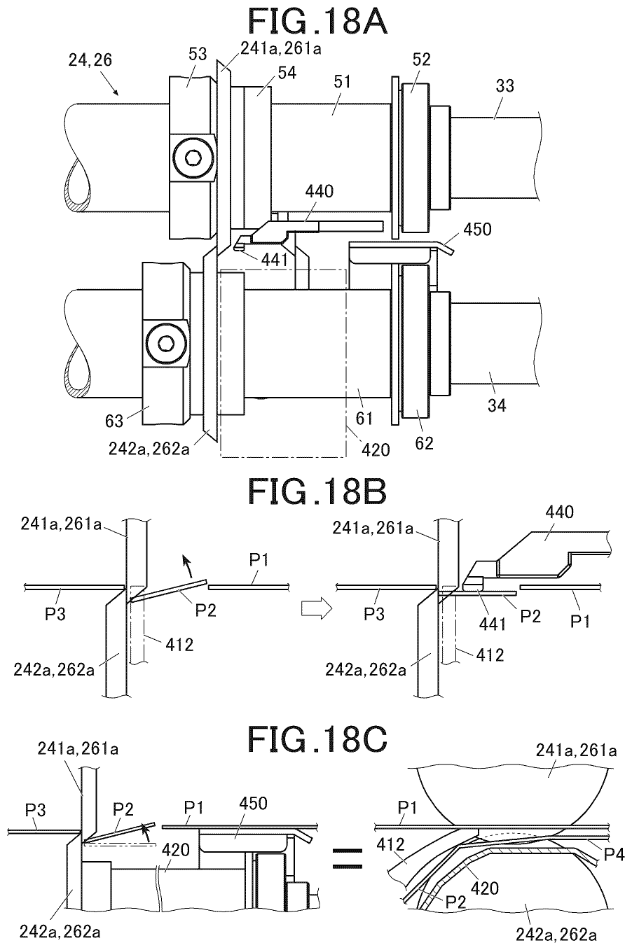

Therefore, as illustrated in FIGS. 18A and 18B, a waste pressing member 440 (waste pressor) is provided that presses the cutting waste generated during cutting downward at a position different from the waste ejection claw 412 and suppresses the inclination of the cutting waste P2 even for a wide cutting waste to stabilize the posture of the cutting waste P2.

The waste pressing member 440 is provided adjacent to a side where cutting wastes are generated at a cutting position by a pair of upper and lower cutter blades 241a, 242a. The waste pressing member 440 is provided so as to extend from the upstream side to the downstream side in the conveyance direction, and a waste pressing piece 441 having a flat lower surface is provided so as to protrude downward at a side edge portion closest to the cutter blade. The lower surface of the waste pressing piece 441 is arranged at substantially the same height as the upper surface of the cutting waste P2 cut by the pair of upper and lower cutter blades, and presses the cutting waste so that the cutting waste immediately after cutting does not tilt (does not rise).

Therefore, the inclination of the cut cutting waste P2 is suppressed by the pressing piece 441 of the waste pressing member 440. Therefore, the cutting waste P2 can be ejected while keeping its posture horizontal without contacting the main body P1. Thus, it is possible to avoid occurrence of JAM due to clogging with dust.

### (Height Difference Forming Means)

When one side (one side of the bleed) of the bleed of the sheet is cut by the cutters 23 and 25 (a pair of upper and lower cutter blades 231a and 232a, and 251a and 252a) on the upstream side, the sheet is divided into the main body P1 and the cut sheet P4 in which the bleed remains. The cut sheet P4 with a bleed is further divided into cutting waste P2 and a main body P3 by cutters 24 and 26 on the downstream side. At this time, if the main body P1 and the cut sheet P4 separated by the upstream cutters 23 and 25 are conveyed to the downstream side at the same height, the cutting waste P2 formed by the downstream cutters 24 and 26 is more likely to incline as the bleed widths are wider, as described above, and thus is more likely to interfere with the main body P1 sent from the upstream side. Therefore, there is provided means for providing a height difference between the main body P1 divided on the upstream side and the cut sheet P4 integrated with the bleed and conveying them to the downstream side.

As illustrated in the 18A of the figure, the height difference forming means is formed by providing a main body conveying member 450 (main body conveyor) adjacent to the waste conveying member 420. The upper surface of the main body conveying member 450 is formed higher than the cutting position of a pair of upper and lower cutter blades (241a and 242a, 261a and 262a) on the downstream side. Therefore, the main body P1 cut by the cutters 23 and 25 on the upstream side is guided to the upper surface of the main body conveying member 450 and conveyed to the downstream side at a position higher than the cut sheet P4. The difference in height between the main body P1 divided on the upstream side and the cut sheet P4 integrated with the bleed is adjusted in the process of assembling the variable bleed width slitter 20 of the present embodiment.

By providing such a height difference forming unit, it is possible to reliably prevent the cutting waste P2 from coming into contact with the main body P1 formed on the upstream side, in combination with the function of preventing the inclination of the cutting waste P2 by the waste pressing member 440. Thus, the posture of the cutting waste can be stabilized to avoid occurrence of a JAM due to waste clogging.

Note that, although the example of the processing apparatus including the two cutters (23 and 24, and 25 and 26) arranged at different positions in the conveyance direction of the sheet has been described in the embodiment described above, the processing apparatus may include three or more cutters arranged at different positions. In this case, the waste ejection member 410, the waste conveying member 420, the discharging member 430, the waste pressing member 440, and the main body conveying member 450 do not needs to be provided in all the cutters on the downstream side, and may be provided in the cutter that ejects the cutting waste.

Furthermore, the example in which the drive mechanisms A, B, C, and D driven by the belts are provided as the relative position adjustment mechanisms (relative position adjuster) that enable adjustment of the relative positions of the plurality of cutters in the direction orthogonal to the conveyance direction has been described, but other drive mechanisms such as a rack-and-pinion may be used.

As described above, the post-processing apparatus 200 according to the present embodiment is an apparatus that includes a conveyance means (the sheet conveyance section 210) for conveying a sheet and is configured such that a plurality of functional units for performing different types of processing on the sheet conveyed by the conveyance means are selectively detachably attached thereto. In addition, as one of the plurality of functional units having different functions, a slitter capable of varying a cut waste width (a variable bleed width slitter 20) is provided. The slitter (the variable bleed width slitter 20) includes at least two cutters (23 and 24, and 25 and 26) which are arranged in the same functional unit and are arranged at different positions in the conveyance direction of the sheet. Furthermore, the slitter includes relative position adjustment mechanisms (drive mechanisms A, B, C, and D) that enable adjustment of relative positions of at least the two cutters in a direction orthogonal to the conveyance direction.

Therefore, it is possible to provide a slitter function capable of varying the width of the cut wastes with a single unit. Therefore, it is not necessary to separately provide the same function in a plurality of units, and the disadvantage that other mounted functions are limited is eliminated.

Here, in the slitter (the variable bleed width slitter 20), each of the at least two cutters (23 and 24, 25 and 26) has two cutter blades (231a and 232a, 241a and 242a, 251a and 252a, 261a and 262a) forming upper and lower pairs with respect to the conveyance surface of the sheet.

Since each cutter (the variable bleed width slitter 20) is formed by two cutter blades forming a pair up and down, the sheet can be smoothly cut by guiding the sheet between the two cutter blades forming a pair up and down.

When such a cutter including two cutter blades forming upper and lower pairs is used, the slitter may include a single cutter blade power source (driving motor 35) that rotationally drives the paired cutter blades (231a and 232a, 241a and 242a, 251a and 252a, 261a and 262a) of each of the cutters (23, 24, 25, and 26).

In such a configuration, since the rotation of each cutter blade can be controlled by a single cutter blade driving source (driving motor 35), the control becomes simple.

Furthermore, the at least two cutters (23 and 24, and 25 and 26) include different blade rests 70 (upper housing 71 and lower housing 72), respectively, and each of the blade rests 70 is independently movable in the direction orthogonal to the conveyance direction of the sheet.

Therefore, by moving each of the blade rests independently in the direction orthogonal to the conveyance direction of the sheet, the positions of the cutter on the upstream side and the cutter on the downstream side in the conveyance direction can be adjusted independently in the direction orthogonal to the conveyance direction of the sheet. Therefore, it is possible to freely change the bleed width at an arbitrary position in the direction orthogonal to the conveyance direction.

In order to realize such a configuration, the slitter (the variable bleed width slitter 20) includes blade rest power sources (a first drive motor 311, a second drive motor 321, a third drive motor 331, and a fourth drive motor 341) that individually drive the respective blade rests 70 in the direction orthogonal to the conveyance direction. Then, each blade rest 70 and the blade rest power source may be connected to each other via a power transmitter (a pulley and an endless belt).

In addition, the blade rest 70 (the upper housing 71 and the lower housing 72) is locked to rotary slide bodies (the upper blade units 231, 241, 251, and 261 and the lower blade units 232, 242, 252, and 262) that rotate and drive each of the two cutter blades paired vertically and slide in a direction orthogonal to the conveyance direction of the sheet. Then, the blade rest 70 may be movable in a direction orthogonal to the conveyance direction together with the rotary slide body.

With such a configuration, the cutter blade can be handled as part of the rotary slide body. In addition, since the blade rest can be locked to the rotary slide body, assembly and handling of the cutter are facilitated.

Furthermore, the slitter according to the present embodiment includes a plurality of blade rests at different positions in the conveyance direction of the sheet, and each blade rest has a sheet guide member that holds the sheet when the cutter cuts the sheet.

By providing this sheet guide member, the sheet conveyed from the upstream side is held when being cut by the cutter, so that occurrence of JAM of the sheet can be avoided and smooth cutting of the sheet becomes possible.

Furthermore, the slitter includes a plurality of blade rests at different positions in the conveyance direction of the sheet, and the blade rest located on the downstream side is provided with a waste ejection member 410 for ejecting cutting waste ejected from the blade rest toward a waste ejection port.

The cutting waste formed by the cutter on the downstream side moves to the downstream side with the conveyance of the sheet, but providing the waste ejection member 410 makes it possible to move the cutting waste toward the waste ejection port 411 and eject the cutting waste from the waste ejection port 411.

Further, the slitter is preferably provided with a waste conveying member 420 for conveying the cut waste toward the waste ejection port 411 on the blade rest.

Providing such a waste conveying member 420 enables the cutting waste guided to the downstream side along the surface of the waste conveying member 420 to be ejected to the outside of the cutters 24 and 26 (the blade rest 70) from the waste ejection port 411.

The waste ejection port is preferably provided with a discharging member 430 for discharging of the cutting wastes.

Since the cutting waste guided to the waste ejection port 411 is charged, the cutting waste easily adheres to and accumulates on the peripheral edge of the waste ejection port 411. However, by providing the discharging member 430 in the waste ejection port 411, it is possible to prevent the waste from adhering to and accumulating on the peripheral edge of the waste ejection port 411.

In addition, the waste ejection member 410 is provided with a waste ejection claw 412 that changes the conveyance direction of the cutting waste toward the waste ejection port 411. Furthermore, the slitter includes, in the blade rest 70, a waste pressing member 440 that suppresses inclination of cutting wastes.

With such a configuration, the cutting waste P2 is pushed by the waste ejection claw 412 and tends to be inclined, but the inclination is suppressed by the waste pressing member 440. For this reason, the cutting waste P2 can be ejected in a state in which the posture thereof is maintained horizontally without coming into contact with the main body. Thus, it is possible to avoid occurrence of JAM due to clogging with dust.

Further, the slitter may be provided with a main body conveying member 450 for conveying the cut sheet main body on the blade rest 70 adjacent to the waste conveying member 420, and the height of one of the main body conveying member 450 and the waste conveying member 420 may be adjustable to the height of the other.

According to such a configuration, a height difference can be provided between the main body part of the sheet separated by the cutter on the upstream side and the cut sheet on which the bleed remains. Therefore, even if the cutting waste formed by the cutter on the downstream side is inclined, it is possible to prevent the waste from coming into contact with the main body formed on the upstream side. As a result, it is possible to stabilize the posture of the waste and avoid occurrence of a JAM due to waste clogging.

The image forming system according to the present embodiment includes an image forming apparatus that forms an image on a sheet, and the above-described post-processing apparatus that performs post-processing on the sheet on which the image has been formed by the image forming apparatus. Therefore, when the above-described post-processing apparatus is adopted, it is possible to form an inline type image forming system in which a slitter capable of varying a cut waste width is mounted as one functional unit.

According to the above configuration, it is possible to provide a post-processing apparatus which can include, as one of functional units, a single unit having a slitter function capable of varying a cut waste width, and an image forming system including the post-processing apparatus.

To achieve at least one of the abovementioned objects, according to an aspect of the present invention, a post-processing apparatus reflecting one aspect of the present invention is a post-processing apparatus comprising: a conveyor that conveys a sheet, wherein a plurality of functional units that perform different types of processing on the sheet conveyed by the conveyor are selectively attachable and detachable to and from the post-processing apparatus; and a slitter that is one of the plurality of functional units, and has a variable cut waste width, wherein the slitter comprises: at least two cutters that are disposed in a same functional unit and are disposed at different positions in a conveyance direction of the sheet; and a relative position adjuster capable of adjusting relative positions of the at least two cutters in a direction orthogonal to the conveyance direction.

Therefore, one unit includes at least two cutters which are arranged at different positions in the conveyance direction of the sheet and whose relative positions in the direction orthogonal to the conveyance direction of the sheet are adjusted by the relative position adjustment mechanism. Therefore, it is possible to provide a function capable of varying the cut waste width by a single unit.

To achieve at least one of the abovementioned objects, according to another aspect of the present invention, an image forming system reflecting one aspect of the present invention is an image forming system comprising: an image forming apparatus that forms an image on a sheet; and the post-processing apparatus that performs post-processing on the sheet on which the image has been formed by the image forming apparatus.

Therefore, by providing the above-described post-processing apparatus in the image forming system, the inconvenience of occupying a plurality of units in order to vary the cut waste width is eliminated.

### <Supplemental>

Although the embodiment and modification examples have been described with respect to the post-processing apparatus and the image forming system including the same according to the present invention, the present invention is not limited to the above-described embodiment and modification examples. The present invention also includes embodiments obtained by applying various modification examples conceived by those skilled in the art to the above-described embodiments and modification examples, and embodiments realized by suitably combining the constituent elements and functions in the embodiments and modification examples without departing from the spirit of the present invention. The scope of the present invention is to be interpreted by the appended claims.

An aspect of the present invention is useful as a technology for providing a single unit with a slitter function capable of varying a cut waste width. Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-053770 filed on Mar. 28, 2024 is incorporated herein by reference in its entirety.

What is claimed is:

1. A post-processing apparatus comprising:
a conveyor that conveys a sheet, wherein a plurality of functional units that perform different types of processing on the sheet conveyed by the conveyor are selectively attachable and detachable to and from the post-processing apparatus; and
a slitter that is one of the plurality of functional units, and has a variable cut waste width, wherein
the slitter comprises:
at least two cutters that are disposed in a same functional unit and are disposed at different positions in a conveyance direction of the sheet; and
a relative position adjuster capable of adjusting relative positions of the at least two cutters in a direction orthogonal to the conveyance direction.

2. The post-processing apparatus according to claim 1, wherein in the slitter, each of the at least two cutters has two cutter blades forming a pair vertically with respect to a conveyance surface of the sheet.

3. The post-processing apparatus according to claim 2, wherein the slitter includes a single cutter blade power source that rotationally drives the paired cutter blades of each of the at least two cutters.

4. The post-processing apparatus according to claim 1, wherein the at least two cutters include different blade rests, respectively, and each of the blade rests is independently movable in the direction orthogonal to the conveyance direction.

5. The post-processing apparatus according to claim 4, wherein the slitter includes a blade rest power source that individually drives each of the blade rests in the direction orthogonal to the conveyance direction, and each of the blade rests and the blade rest power source are connected to each other via a power transmitter.

6. The post-processing apparatus according to claim 5, wherein
in the slitter, each of the at least two cutters has two cutter blades forming a pair vertically with respect to a conveyance surface of the sheet, and
each of the blade rests is locked to a rotary slide body that rotationally drives each of the two cutter blades and moves each of the two cutter blades in the direction orthogonal to the conveyance direction, and each of the blade rests is movable in the direction orthogonal to the conveyance direction together with the rotary slide body.

7. The post-processing apparatus according to claim 4, wherein the slitter includes a plurality of the blade rests at different positions in the conveyance direction of the sheet, and each of the blade rests has a sheet guide that holds the sheet when each of the cutters cuts the sheet.

8. The post-processing apparatus according to claim 4, wherein the slitter includes a plurality of the blade rests at different positions in the conveyance direction of the sheet, and a blade rest located on a downstream side is provided with a waste ejector to eject cutting waste ejected from the blade rest toward a waste ejection port.

9. The post-processing apparatus according to claim 8, wherein the slitter includes, in the blade rest, a waste conveyor that conveys cut waste toward the waste ejection port.

10. The post-processing apparatus according to claim 8, wherein the waste ejection port is provided with a discharger that eliminates charge of the cutting waste.

11. The post-processing apparatus according to claim 8, wherein the waste ejector is provided with a waste ejection claw that changes a conveyance direction of the cutting waste toward the waste ejection port, and the slitter includes, in the blade rest, a waste presser that suppresses inclination of the cutting waste.

12. The post-processing apparatus according to claim 9, wherein the slitter includes, in the blade rest, a main body conveyor to convey a main body of the cut sheet adjacent to the waste conveyor, and a height of one of the main body conveyor and the waste conveyor is adjustable with respect to a height of the other of the main body conveyor and the waste conveyor.

13. An image forming system comprising:
an image forming apparatus that forms an image on a sheet; and
the post-processing apparatus according to claim 1 that performs post-processing on the sheet on which the image has been formed by the image forming apparatus.
